(19) United States
(12) Patent Application Publication
(10) Pub. No.: US 2019/0347683 A1
(43) Pub. Date: Nov. 14, 2019

(54) METHOD FOR MANAGING MEDIA CONTENT OF A POINT OF INTEREST UNDER SPONSORSHIP AND SYSTEM THEREOF

(71) Applicant: Framy Inc., Grand Cayman (KY)

(72) Inventor: Yu-Hsien Li, TAIPEI CITY (TW)

(21) Appl. No.: 16/178,609

(22) Filed: Nov. 2, 2018

(30) Foreign Application Priority Data
May 11, 2018 (TW) 107116158

(51) Int. Cl. G06Q 30/02; G06F 17/30; G06Q 50/00

(52) U.S. Cl. CPC G06Q 30/0214; G06F 17/30867; G06Q 30/0261; G06F 17/30241; G06Q 50/01; G06F 17/3087

(57) ABSTRACT

The disclosure is related to a method for managing media content of a point of interest (POI) with sponsorship and a system thereof. A sponsor sets up sponsored content relating to a POI and a reward criterion in the system. A server of the system queries a database according to a positioning data generated by a user device so as to acquire one or more POIs with the sponsored content. The system then provides information relating to the POI with the reward to the user. The user arrives at the POI and opens a POI page that may include sponsored content. After that, one media content can be created and uploaded to the server. The system provides a reward to the user when the server confirms the media content meets the reward criterion. A link for the media content can be created in association with the POI.

### CROSS-REFERENCE TO RELATED PATENT APPLICATION

This application claims the benefit of priority to Taiwan Patent Application No. 107116158, filed on May 11, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The disclosure is generally related to a method and a system for managing media content, in particular to a method for managing attracting users to create media content at sponsored POI (Point Of Interest) for achieving a sponsorship and a management system thereof.

### BACKGROUND OF THE DISCLOSURE

General social media not only provides services for social activities, but has also replaced the traditional media to become a content center, a news center or a shopping platform. This has attracted advertisers to advertise their products or services through social media since the social media can effectively obtain its users' personal data such as their genders, ages, interests and professions through big-data analysis. The social media allows the advertiser to set up the preferred marketing audience. For example, if a product is designed for women, the advertiser of the product may set up its marketing audience as women; if an electronic product is provided, the advertiser may set up a specific age range of users to be the targets for marketing; and mothers with children can also be the marketing targets when infant products are advertised.

In the social media and other types of media such as web portals and blogs, the conventional advertisement thereon shows the company's contact information such as an address, a website URL, a social media user name, a telephone number or an electronic mail that allows the social media users who are interested in the advertisement to click for obtaining further information relating to the company.

However, despite that it may be possible for advertisers to learn the number of visitors directed to their websites from relevant advertisements, it is not easy for the advertiser owning a physical store to grasp which of their customers were led to their store through said advertisements. Therefore, it is not easy to evaluate the advertising performance. The advertiser can only constantly spend money on marketing despite the uncertainty of the advertisement performance.

Reference is made to FIG. 1, which is a schematic diagram showing a conventional scenario of submitting an advertisement to social media. In the diagram, a user 10 browses a content of a social network site using a user device 12 that executes a social community program 120. The content may also be one posted on a blog, a web page, or a search result obtained by a search engine. An advertisement 122 is embedded in the content. The advertisement 122 is generally a content that attracts the user 10 to click for obtaining further information. The advertisement 122 can be used to direct the user 10 to a web page 14 or an address and contact information of the store 16. An ultimate goal of the advertisement 122 would be to direct the users to come to the physical store for purchasing products.

Aside from using inquiries or questionnaires, it is difficult for the advertiser to know which of the visiting customers in the physical store 16 have come through the advertisement 122 submitted to the social community program.

### SUMMARY OF THE DISCLOSURE

In response to the above-referenced technical inadequacies, the present disclosure provides a method and a system for managing media content for Point of Interest (POI) under sponsorship.

In view of the drawback that it is not easy to determine advertising performance, traditional marketing advertisements submitted to social media, blogs, or webpages perform poorly. The disclosure provides a management method or a system for point-of-interest media content. An aspect of the invention of the disclosure is to allow an advertiser to submit an advertisement to the system for managing media content for POI and to set up the advertisement content. The content may be an address and introduction of the physical store or include a criterion for rewarding users. A proportion and a criterion for rewarding can be set up in the management system. Information of a point of interest with reward can be messaged to the users. The users can arrive at the store for creating a media content according to a requirement of the system and the advertiser. The media content can be any combination of text, voice, picture and video, and a positioning data can also be carried with the media content. The media content is then uploaded to a server of the system for managing media content for POI. The system can provide a reward to the user when it determines the uploaded content is in compliance with the reward criterion.

The disclosure also provides a management method for a system for point-of-interest (POI) media content under sponsorship. An aspect of the invention of the disclosure is to allow a sponsor to submit a sponsored data with respect to POI to the system for managing media content for POI and to set up the sponsored content. The content may be an address and introduction of the physical shop, a building or a scenic spot, or include a criterion for rewarding users. A proportion and a criterion for rewarding can be set up in the management system. Information of a point of interest with reward can be messaged to the users. The users can arrive at the location of POI for creating a media content according to a requirement of the system and the sponsor. The media content can be any combination of text, voice, picture and video, and a positioning data can also be carried with the media content. The media content is then uploaded to a server of the system for managing media content for POI. The system can provide a reward to the user when it determines the uploaded content is in compliance with the reward criterion.

Through the method and system for managing the media content for POI, the user can see the sponsored content when he approaches the POI. Since the sponsored content set by the sponsor can attract the user to proceed to the POI, the sponsor can therefore review the substantial sponsorship benefit. The sponsor can be an individual person, a company, a store owner or the like who wants to reach a purpose of marketing through the sponsorship. A user who may become a consumer can create a media that meets a discount and reward criterion when he arrives at the POI.

According to one embodiment of the disclosure, the method for managing media content of a POI is operated in a server of the management system. When the server receives positioning data generated by a user device via a network, a software program operated in the server conducts a query of a database. One or more POIs corresponding to the positioning data can be obtained. If any POI has a reward criterion, the server provides information of the POI with reward by the user device. For example, the server can actively provide positioning information of the POI, and the information of the sponsor. The POI with reward can be a location to be sponsored set by one or more sponsors through the management system. It should be noted that the location to be sponsored is not limited to a physical shop, and the POI with reward can be associated with one or more sponsored data.

After that, the user brings the user device to proceed to the position of the location to be sponsored, and creates a media content such as a video relating to the location. When the media content is uploaded to the server, the software program running in the server verifies whether or not the location where the media content is crated matches the reward criterion. If the media content matches the criterion, the system provides a reward to the user. It should be noted that the reward is a portion of benefit from the fee submitted by the sponsor.

Further, in the server, a media content link is applied to the media content for associating with the point of interest. The media content link allows other users to see the media content when they approach the location, i.e. the point of interest.

Further, the user can explore a geographical range using an electronic map on the user device. A positioning data regarding the geographical range is generated. The positioning data is uploaded to the server for comparison, and one or more POIs associated with the geographical range can be obtained. The system can also provide the information of the POI(s) with reward(s) and the sponsor. The information can attract the users to proceed to the POI for gaining the reward.

In another aspect of the disclosure, a positioning circuit of a user device generates positioning data when the user device is at a location. The positioning data is uploaded to the server of the system for managing media content for POI. After querying a database, if any POI with reward corresponding to the positioning data is found in the database, the system proactively transmits an invitation message to the user device that generates the positioning data. The invitation message includes the position, reward criterion relating to the POI, and/or the sponsor information.

The user-end software program provided by the management system allows the user to browse information of POIs. When approaching any POI with reward, the software program reminds the user or initiates an option menu for the user to make a selection. The system then provides information of the selected POI to the user device and displays the information by a POI page. The user can decide if he wants to get the reward.

Furthermore, when the server receives the selection of POI by the user from the user device, the system utilizes the POI page to show the sponsored content via a carousel mode, a side-by-side mode or an option mode if the POI associates with multiple sponsored data.

Further, the sponsor sets up sponsored content by a sponsorship setting page provided by the server so as to create a POI with reward. The information of the POI includes a POI name, a POI location, a sponsorship time, a target user condition and reward criterion.

In one embodiment of the system for managing media content for POI, a server and a database are provided. The server utilizes one or more processors to perform the method for managing media content for POI. A database is used to record POIs set up by a plurality of sponsors. The POI data includes information of POI, location of POI, sponsored data, and a related reward criterion. Furthermore, when the POI is sponsored by more than one sponsor, the system provides sponsored data to the system user according to a sorting policy.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 shows a schematic diagram depicting a circumstance with advertisement set through a social community media in a conventional technology;

FIG. 2 shows a schematic diagram depicting a system framework of a system for managing media content for POI under sponsorship according to one embodiment of the disclosure;

FIGS. 3A to 3D show schematic diagrams depicting a sponsored content that is set via a user interface in one embodiment of the disclosure;

FIG. 4 shows a flow chart describing a process implemented by a method for managing media content for POI under sponsorship in one embodiment of the disclosure;

FIG. 5 shows one further flow chart describing a process implemented by a management method under sponsorship in one further embodiment of the disclosure;

FIG. 6 shows another flow chart describing a process implemented by a management method under sponsorship in another embodiment of the disclosure;

FIG. 7 shows one further flow chart describing a process implemented by a management method under sponsorship in one further embodiment of the disclosure;

FIG. 8 shows another flow chart describing a process implemented by a management method under sponsorship in one embodiment of the disclosure;

FIGS. 9A to 9C show schematic diagrams depicting a process of exploring the POIs in the method for managing media content for POI according to one embodiment of the disclosure;

FIGS. 10A to 10C show schematic diagrams depicting another process of exploring the POIs in the method according to one embodiment of the disclosure;

FIGS. 11A to 11C show schematic diagrams depicting a process of notifying a user of the information of a POI with reward in the method of one embodiment of the disclosure.

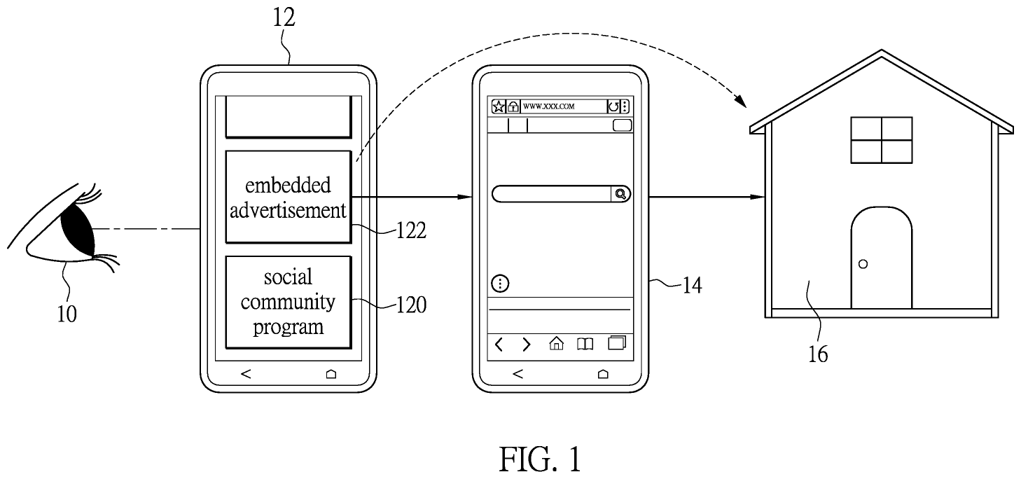

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

An advertiser may represent an owner of a physical shop who submits an advertisement to a specific network media for attracting people to click the advertisement and visit a website or to get further information of shopping in the store. A visit rate counted by clicks (click through rate, CTR) of the website is referred to, to calculate the advertisement fee. However, it is difficult for the advertiser to evaluate the performance of the advertisement. The management system operated under sponsorship allows the sponsor to clearly acknowledge the users arriving at the POIs to be sponsored. According to the purpose of sponsorship, the sponsor can obtain the clear and definite sponsorship outcome. It is worth noting that the POI with reward of the system is a location where one or more sponsors can set up sponsorship via a platform constituted by the system or a cloud-based system. This location is not limited to any physical shop or a geographical location related to the sponsor. The location forms a point of interest that can be a scenic spot, an area, a building or a physical shop. Thus, a POI with reward can associate with a plurality of sponsors and therefore with one or more sponsored data.

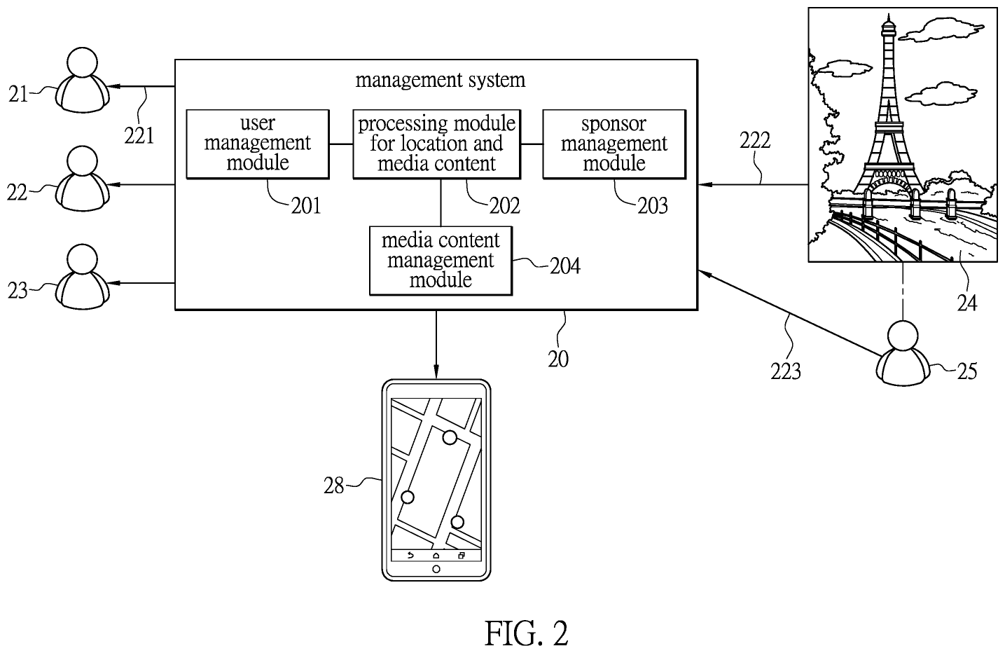

An aspect of the system for managing media content for POI under sponsorship can be referred to a schematic diagram of a system framework shown in FIG. 2.

This figure shows a computer-implemented system for managing media content for POI 20. The system includes a server that includes one or more processors for performing the method for managing media content for POI. The functionalities operated in a software process can be categorized into a user management module 201, a processing module for location and media content 202, a sponsor management module 203 and a media content management module 204.

The user management module 201 is used to manage users of the management system. The user registers in the management system via a software program installed in a user device. The software program allows the user device to communicate with the management system, e.g. transmitting positioning data and acquiring information of POI from the management system.

A scenic spot 24 is shown in the figure. The scenic spot 24 is a location that the sponsor decides to submit advertisement 222 through the management system 20. The system initiates an advertisement setting page for the sponsor to set the advertisement 222 through a sponsor management module 203. The advertisement setting page allows the sponsor to set up a location, a type, the content, a time related to the advertisement, and a target user or group. After that, the system also requires the sponsor to set up a criterion for rewarding the user. Then the sponsored advertisement 222 is submitted to the management system 20.

It should be noted that the advertisement may sponsor a famous scenic spot or location so as to reach an effect of advertisement even if the sponsored advertisement is not directly for the physical shop or any specific location. The management system 20 includes a database (not shown in the diagram) that links the computer-implemented server. The database records a plurality of POIs set by multiple sponsors. The information of POI includes a POI name, a POI location, sponsored content, a sponsorship time, a target user condition and a reward criterion.

Several users 21, 22, 23 and 25 at different locations are shown in the diagram. The users 21, 22, 23 and 25 may become the users of the management system 20. When the user management module 201 verifies a user, the user receives a request for media from the system. The information regarding the reward for the POI may be transmitted to the user device. The users 21, 22, 23 and 25 are invited to come to the POI location regarding the scenic spot 24 set by the sponsor for creating a media. The media is uploaded to the system and the user can be rewarded.

In the present example, the user 25 arrives at the scenic spot 24, and a media is created according to a reward criterion. For example, the media is such as a video or photos about the scenic spot 24, or a description of the scenic spot 24. The media 223 is then uploaded to the management system 20. The processing module for location and media content 202 is then applied to process the media 223 uploaded by the user 25. In an exemplary example, the processing module 202 retrieves an uploading location of the media, and determines whether or not the media meets the reward criterion according to the location of the scenic spot 24. The sponsor can then verify if the media content meets the reward criterion, and the management system 20 can still analyze the media content by the processing module 202 automatically. The processing module 202 retrieves features of images, texts and/or sounds from the media. The features of media are used to compare the feature regarding to the scenic spot 24 for verifying if the media content meets the reward criterion regarding the scenic spot 24, or if the media content meets the criterion set the sponsor.

After confirming that media content meets the reward criterion, the management system 20 utilizes the user management module 201 to reward the user 25. The reward is recorded to a corresponding to a user account, or sent to the user as a discount for goods or services. The media content management module 204 then creates a media content link associated to the POI of scenic spot 24. The media becomes the content 28 that can be displayed on a user device. The media content with the link can be searched, browsed and as a reachable information of POI for others.

If one POI is associated with more than one sponsor, the system provides the sponsored content to the user based on a sorting policy. For example, when the interface user does not provide sufficient space to show the sponsored content, the system can deliver the advertisement under a carousel mode. The sorting policy can refer to a fee submitted by the sponsor and/or a reward criterion such as the price. Alternatively, the system sorts the sponsored content according to the time to submit the advertisement.

In one further embodiment of the disclosure, when one POI associates with multiple sponsors and sponsored data, the user interface should provide sufficient space to display the related sponsored content. A side-by-side mode can be used to display the sponsored content on the POI page shown on the user device. Each sponsored content acts as a link button for the user to click. Alternatively, the POI page can use a menu, e.g. a drop-down menu, to allow the user to make a selection from the listed sponsored content. Then the user can see the content of interest.

It is worth noting that the mentioned rewards for POIs are used to encourage and reward the user who creates a media at a POI and uploads the media to the system. The media can be any or a combination of a text, a sound, an image and a video. The system provides a substantial reward such as an advertisement reward to the user who reaches the reward criterion. The advertisement reward is provided by the sponsor who pays a fee for advertising when submitting the advertisement at the POI. The system for managing media content for POI shares a portion of the advertisement fee to the user who reaches the reward criterion. The reward is not limited to any type of rewarding. The reward is benefit sharing from the effect of advertisement based on the media content uploaded by the user. For example, a virtual currency can be provided by the system or a platform for the users to purchase goods or services as real money. Further, the reward can also be transferred to the user's financial account. The discount for goods or services is such as a discount to consume in the sponsor's physical or virtual shop or brand. The reward is actually set based on the sponsor or user's preference.

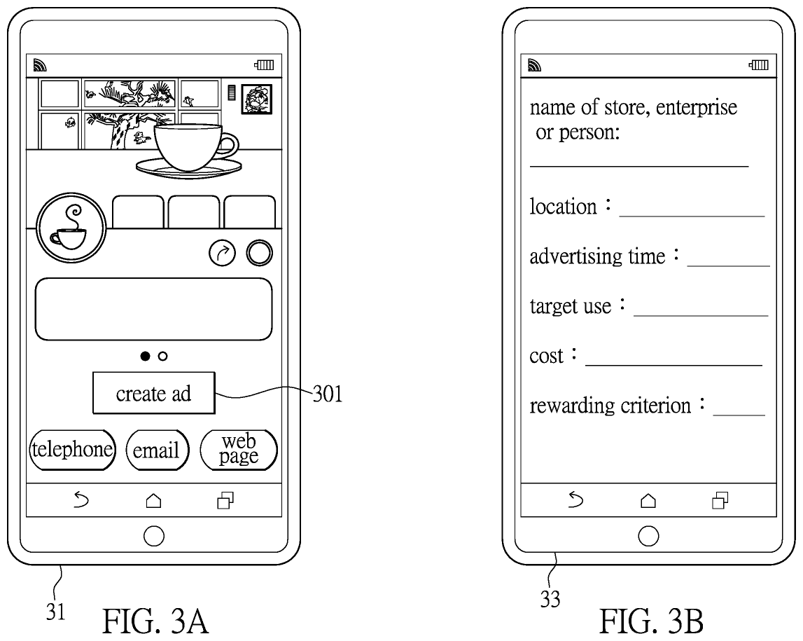

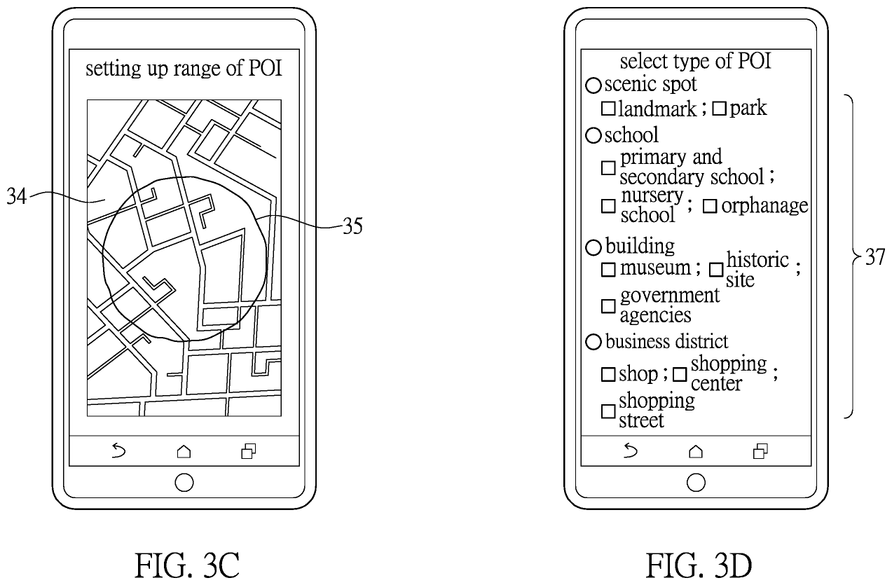

The sponsor uses a software program installed in a computer to link to the system for managing media content for POI for setting an advertisement. References are made in FIGS. 3A through 3D that schematically show the user interfaces provided for the sponsor to set up sponsored content according to one embodiment of the disclosure.

FIG. 3A schematically shows a sponsor page 31 that is displayed on a user device. The sponsor page 31 is a main page that allows an advertiser or a sponsor to set up the sponsored content. For a general sponsor, the POI can be a specific type of spot within an area, for example a park, a school, or a shop. Through the sponsor page 31, the sponsor can set up the sponsored content by selecting a certain geographical range on a map, or designating a specific area such as a nation, a county or a lane. In general, the POI page or over pages allow the sponsor to set up sponsored content including a telephone number, an electronic mail address, and a web page. A start button 301 is provided through the sponsor page 31 for the sponsor to create an advertisement for accessing a sponsored content setting page.

FIG. 3B schematically shows a sponsored content setting page 33 that is provided for the sponsor to set up a sponsored advertisement. It is different from the advertisement specified to the physical shop, the scheme of the present example allows the sponsor to be free to set up a POI for a non-store location. In an exemplary example, the POI ca be referred to any geographical location, and the sponsored advertisement is not limited to be specified to a specific location. Once the advertisement is set to specific location, the information of the sponsored advertisement can be shown on a browser page when the user browses the related geographical area. It should be noted that the advertisement not specified to the physical shop can be regarded as an image advertisement. The sponsored advertisement can be associated to a famous scenic spot for the purpose of enhancing awareness. When the sponsored advertisement is submitted to another shop page that has business cooperation, the association there-between can also enhance the business relationship and awareness. Thus, any POI with reward can be associated with one or more sponsors that also relate to one or more sponsored data.

On the sponsored content setting page 33, the sponsor inputs the name of a shop, a company/enterprise or a person that can be used as a title of the sponsored content of the POI. The sponsor inputs a location of the POI by selecting a specific type of POI within an area via an electronic map. For example, the POI coverage can be a park, a school, a restaurant or a building.

The system can preset a certain range for each POI according to its attribute. For example, an enterprise can strengthen its corporate image by adopting a POI such as an orphanage, a nursing home or a park with an area through the system for managing media content for POI.

Further, the sponsor sets a time for the sponsorship on the sponsored content setting page 33. The time for the sponsorship indicates a period of time for advertising such as daily time or weekly time. The target user can be set for designating a group of users for the reward such as the user's gender, geographical range, age and/or a tracking number with respect to the user who are invited to create the media for the reward. The sponsor is also asked to pay an advertising fee and set up a reward criterion.

In one embodiment, the sponsored POIs may point to the POIs with a specific type or multiple POIs with multiple types within a geographical range. An electronic map 34 shown in FIG. 3C can be provided for the sponsor to circle a range of sponsorship 35 so as to set up the POIs with sponsorship. In the meantime, the system provides a number of POIs by querying a database according to the circled range with altitude and longitude. The POIs from the system are provided for the sponsor to select the one or more POIs with sponsorship. However, the abovementioned embodiments do not limit the scope of the invention since the selection of the geographical range or the types of POI made by the sponsor may still utilize other methods. For example, the sponsor can use keywords to find out the POIs of a specific type via the setting page 33.

Further, as shown in FIG. 3D, the system categorizes the plurality of POIs into several types. For example, a scenic spot POI can be a landmark or a park; a school POI is such as a primary and secondary school, a nursery school or an orphanage; a building POI can be a museum, a government agency, or a historic site; a business district can be a shop, a shopping center, or a shopping street. These types of POI form a sponsor type option 37 provided for the sponsor to make a selection. Through the option 37, the sponsor can set up multiple sponsored POIs, or multiple POIs that cover multiple types of POI at once. The sponsored POI is generally not specified to any shop or location but based on the sponsor's requirements. The system generally allows an individual, a government agency, a company without any physical shop, or an online shop to submit the sponsorship according to their requirements.

For example, when a sponsor wants to submit sponsorship onto all parks in London England, an electronic map 34 allows this sponsor to find the London city and zooms in to see the entire city of London. Further, the sponsor can select a range of the London city using his finger or a circling tool for setting up a sponsored range 35. In the meantime, the system receives a set of coordinate data with respect to the sponsored range 35 from the user device. A plurality of POIs can be found within this sponsored range 35 by querying a database. The POIs are provided for the sponsor to decide which are the POIs to be sponsored. The above-mentioned embodiment shows that the categories of POIs provided by the system form an option of types of POI for the user to select which one he wants to sponsor.

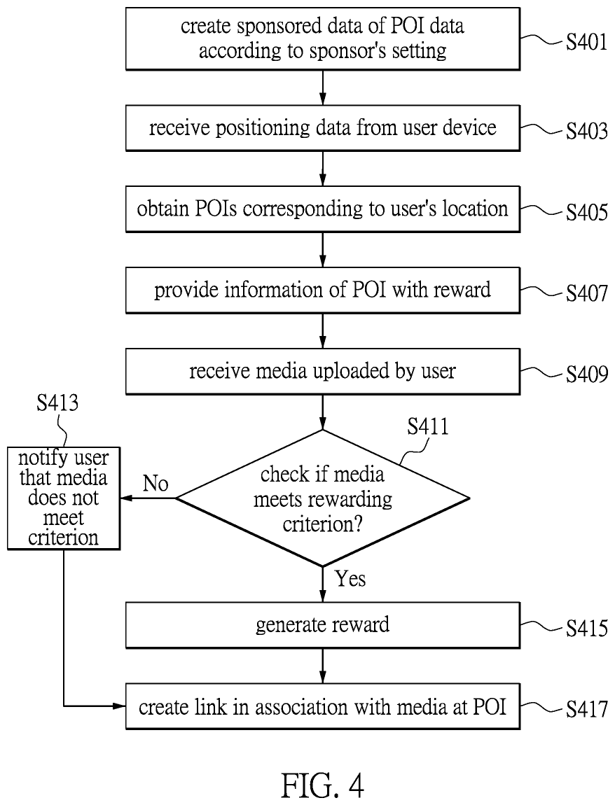

For the cloud-based system for managing media content for POI under sponsorship, a software program is installed in a user device and the software program is used to communicate with the system. The method operated in the user device is illustrated in FIG. 4.

In the present example, such as in step S401, the system for managing media content for POI establishes a database including data of POIs according to the reward criterion set by sponsors. The reward criterion regulates a requirement to create a media that qualifies for the reward. The reward criterion is such as taking a picture or a video when the user arrives at the location of POI or within a range of the POI. The media content may be required to regard the POI. More, the sponsor can require the user to create the media covering the POI or about the sponsored content in the reward criterion.

When the management system is in operation, such as in step S403, a software process operated in a server of the system continuously communicates and exchanges data with a software process running in the user device. The system constantly receives the positioning data generated by the user device. A user ID and GPS of the device are included in the data sent to the system. Further, the positioning data received by the system can also be the location where the user explores using an electronic map, or a location page, e.g. the explored pages with reward that the user freely browses. The software program operated in the system obtains the positioning data with respect to the location according to POI.

When the system obtains the positioning data generated by the user device, such as in step S405, the system continuously queries the database to find out the POIs that match the positioning data. In one further embodiment, the sponsor can find the users who match the conditions according to POI location, the target user, and time through the management system. In step S407, the system filters out the users that match the target user condition, and transmits information of the POIs with reward. Thus, the system can proactively send an invitation message to one or more users to acquire rewards at the POIs.

Further, the user may explore one or more POIs with reward according to his positioning data at the same time. In the meantime, the system may provide an option for the user to choose which POI to proceed to for the reward. Alternatively, the system may actively provide a sorting of the POIs with reward to the user matching a target user condition, to then transmit the information of a POI with reward selected by the target user to the target user. The POI with reward can include one or more sponsored data set by one or more sponsors. The related sponsored content can be shown by a carousel mode, a side-by-side mode or an option mode that is provided for the user to select the interested sponsored content.

In step S409, the user arrives at the POI and creates a media using his user device. The media is uploaded to the system. When the system receives the media from the user, in step S411, the system verifies if the media meets the reward criterion. If the media does not meet the reward criterion, e.g. the location error or content mismatching, the system notifies the user that the media does not meet the reward criterion (step S413). In one embodiment, the completed media can still be uploaded to the management system and associated with a link at a POI even if it does not meet the reward criterion (step S417). The location where the media is created and uploaded can still be a POI. On the contrary, the system provides a corresponding reward (step S415) if the system verifies that the media meets the reward criterion. The type and content of reward can be based on setting by the sponsor in the system. Similarly, the system creates a media content link associated to the POI (step S417).

No matter whether or not the media uploaded from the user meets the reward criterion corresponding to the POI, the media can still be a link on the map. The links on the electronic map are provided for others to explore, browse and show the media content with respect to the POIs.

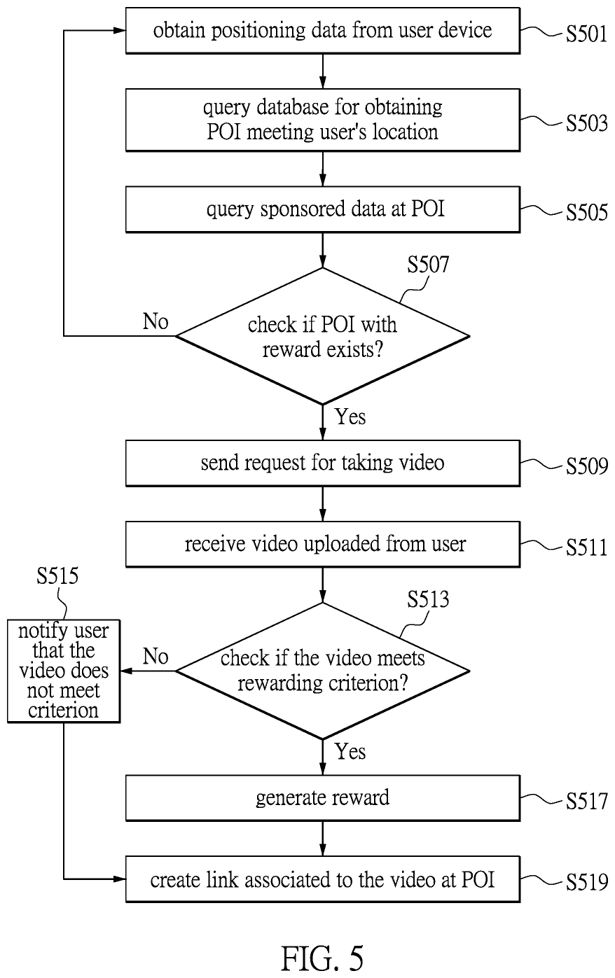

Reference is made to FIG. 5, which shows a flow chart describing the method for managing the media content for POI. The process in the flow chart describes that the user can be notified of the nearby POIs with reward according to his location.

In the beginning, such as in step S501, the system receives positioning data generated by a positioning circuit, e.g. GPS circuitry, of a user device. In step S503, the software program running in the system queries the database according to the positioning data so as to get the POIs corresponding to the user's location. In step S505, the system queries the data of sponsored content with respect to POIs in the database for confirming the conditions such as the time, time limit and target user for advertising. After that, the system determines whether or not any POI with reward exists according to a querying result (step S507).

If the querying result shows that no POI with reward exists in the database, the system will not provide any information about the POI with reward but can still show the information of the general POIs. The process then goes to the beginning step S501.

On the contrary, if the querying result shows any POI with reward matching the positioning data generated by the user device, the system will actively transmit the POIs with reward to the user device (step S509). Furthermore, a request inviting the user to shoot a video is sent to the users who match the target user condition with respect to the POI due to the advertisement. The POI location and a reward criterion with respect to the POI with reward are provided for the user while sending an invitation message to a user device.

When the user receives the information of POI with reward accompanied with the invitation message, the user arrives at the POI and creates a media, e.g. making a video, according to a reward criterion. In step S511, the media is uploaded to a server of the system. The server receives the video, and a software program running in the server is used to retrieve information such as a location, a length, and features of content from the video (step S513). The information allows the system to verify if the video meets the reward criterion.

If the video does not meet the reward criterion, such as in step S515, the system notifies the user that the video does not meet the criterion. The system can still create a link associated to a location (step S5190). On the contrary, if the video meets the reward criterion after analyzing its information, such as in step S517, the system provides a reward that is calculated according to the sponsor's advertising fee. Similarly, in step S519, a link associated with this video can also be created at the POI.

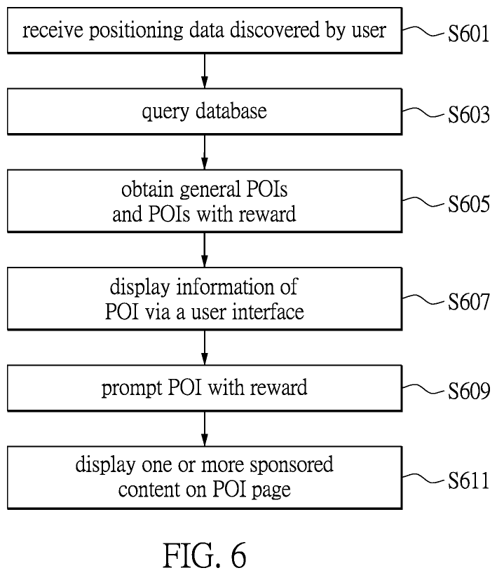

FIG. 6 shows another flow chart describing the method for managing media content for POI under sponsorship in another embodiment of the disclosure.

In the present embodiment, a user manipulates a user device to explore an area or search with some specific keywords. While exploring the area, positioning data relating to the area is generated. In step S601, the system receives the exploring data uploaded from the user device. The exploring data corresponds to an area that can be a display area shown on the user device. The area may be changed in response to the user's manipulation, e.g. zoom in or zoom out. When the system receives the positioning data based on the change, such as in step S603, one or more POIs can be obtained by querying a database according to the positioning data. The one or more POIs within the range are displayed on the user device, and the POI with reward will be labeled on the electronic map.

In the meantime, such as in step S605, the POIs including some general POIs and some POIs with reward are found. In step S607, a user interface is used to show the information of POIs. The POIs with reward can be explored and marked on an electronic map. In step S609, a list menu can be provided for the user to select multiple POIs with reward. In step S611, when the user selects one of the POIs listed in the menu, a POI page is initiated. The POIs with sponsored content can be highlighted by various ways on the POI page.

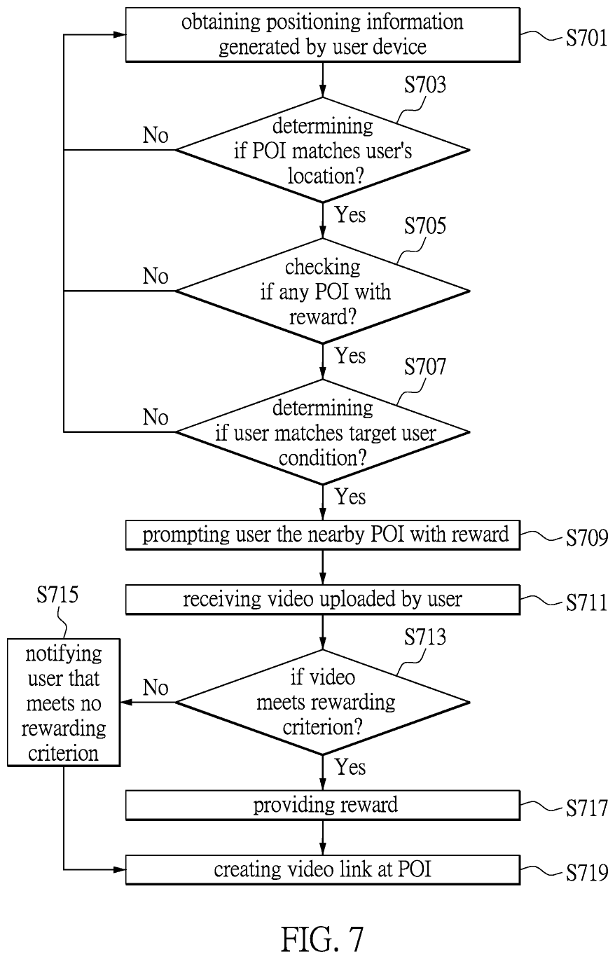

In one further embodiment shown in FIG. 7, the system provides a proprietary software program executed in the user device that is carried by the user. The positioning circuit of the user device continuously generates the positioning data, and the system constantly receives the positioning data (step S701). The system can identify the user in the process to determine whether the user matches target user conditions, and can query the database according to the received data to determine whether or not any POI matches the user's location (step S703).

In the software process, if the system finds no POI near the user within a geographical range set by the user or the system, the process will repeat the above-mentioned steps S701 and S703 until a nearby POI is found.

If any nearby POI is found, the system allows the user to choose one or more POIs within the geographical range. In step S705, the software program running in the system checks if any POI with reward exists within the geographical range.

If no POI with reward is found within the geographical range after querying the database, the process goes to step S701 and repeats the mentioned steps. On the contrary, if at least one POI with reward set by at least one sponsor within the range is found, the process goes to step S707 for determining whether or not the user is qualified to get the POI with reward. This step is used to check if the user matches the target user condition associated with the POIs.

If the system confirms that the user is the target user of one of the POIs, an icon or a specific mark is used to label the one or more POIs with reward to the user (step S709). Therefore, the user can choose one or more POIs in which he is interested. After the user chooses one of the POIs, the system provides the information of POI and the information will be shown on a page.

In step S707, if no POI with reward is matched with the user, the system may provide only the normal POIs registered in the system and repeat the steps S701, S703 and S705.

In one embodiment, such as in step S709, the software program running in the user device receives the information regarding the nearby POIs with reward from the system. For example, a symbol can be shown on a page for prompting that a certain location contains a POI with reward. Alternatively, the user can be prompted by vibration or sound activated by the software program. If multiple POIs with reward corresponding to the positioning data are found, a selection menu can be provided for the user to make a selection.

After that, in step S711, the user can select one of the POIs that show the sponsored content and get the information, e.g. of the reward criterion. The user then arrives at the POI, shoots a video regarding the POI, and uploads the video to the system. The software process running in the system determines if the video uploaded from the user device meets a reward criterion associated with the POI after receiving the video (step S713).

If the video does not meet the reward criterion, the process goes to step S715 for notifying the user that the video is not qualified to get the reward. Similarly, such as in step S719, a link associated with the video can still be created on the electronic map. It the video meets the reward criterion set by the sponsor, a reward is provided after confirmation (step S717). A link associated with the video is created at the POI (step S719).

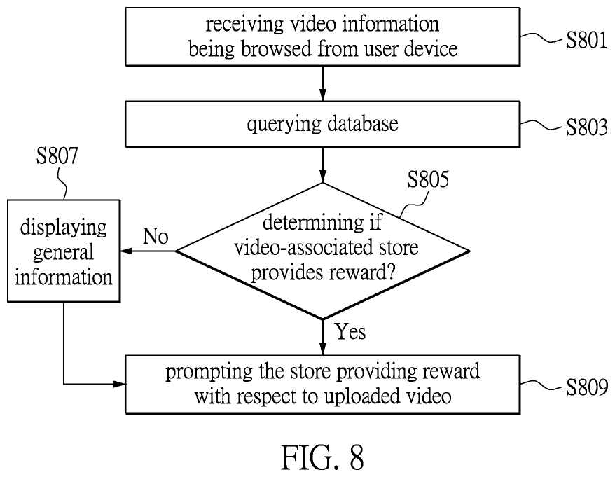

Referring to a flow chart shown in FIG. 8 according to one embodiment of the disclosure, the user can be prompted to check the POIs with reward when he browse the locations or store pages using a browser program. In step S801, the system receives information while browsing the video associated with the POI by the user device via a network. The system will reply with POI information such as the location of POI. The system then queries the database (step S803) according to the location of POI, and determines whether or not the location corresponding to the video provides the sponsored content and reward to the user (step S805).

If the POI does not provide a reward, i.e. no sponsor, the process goes to step S807 for showing general information of the POI. If the POI provides the reward, i.e. with sponsored advertisement, such as in step S809, the system prompts the user that the location corresponding to the video, i.e. the store providing the advertisement, offers the reward for the user who uploads a video about the location.

If one POI includes multiple sponsored content, the system utilizes a carousel mode, a side-by-side mode or an option mode to show the sponsored content dynamically according to an available display space. Then the user can select his interested sponsored content from the page.

The system receives an instruction specified to select a POI when the user manipulates the user device to browse the locations and make a selection. The POI location is sent to the system. The system shows a POI page via the user device. If the POI is applied with a reward criterion, the POI page shows a reward prompting icon, one or more sponsored content and other media content associated with the POI.

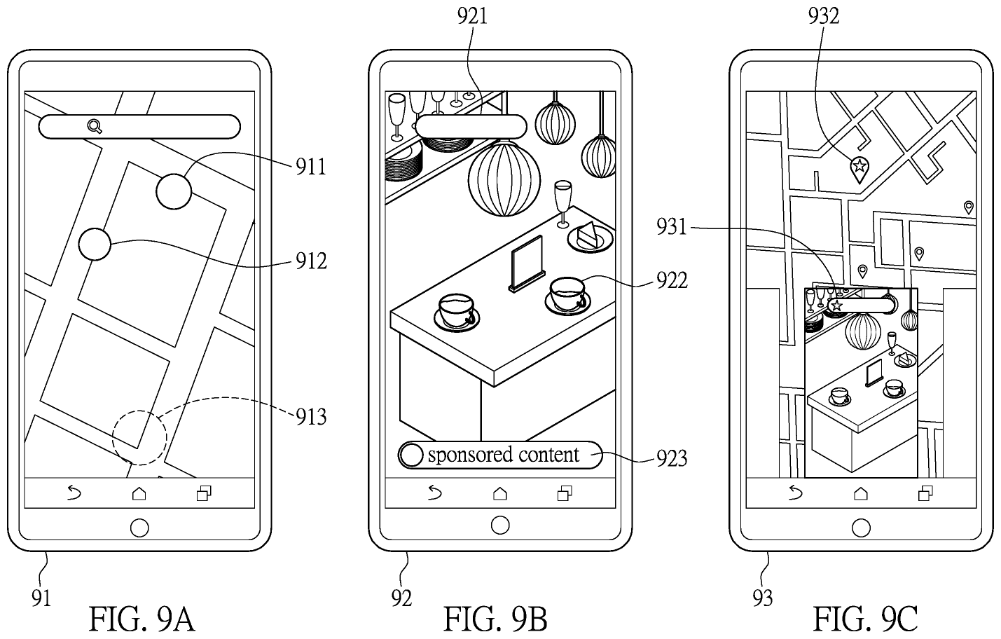

Next, FIGS. 9A through 9C show schematic diagrams depicting exploration scenarios of POIs in the management method operated in a user device according to one embodiment of the disclosure.

FIG. 9A shows a POI exploration page 91. Two POIs 911 and 912 are shown in the electronic map. The POIs 911 and 912 are obtained by querying the database according to positioning data transmitted by the user device. A shooting button 913 is provided on this page to allow the user to film immediately.

FIG. 9B shows a POI page 92. The POI page 92 schematically shows an image of a scenic spot associated with the POI that is selected by the user. The image represents the media content 922, e.g. a video, associated with the POI. If this POI provides a reward, a reward prompting icon 921 can be used to prompt the user to get the reward at the POI. If the reward is provided by a sponsor, the POI page 92 shows the sponsored content 923 in a specific zone. The sponsored content 923 may include a name of company, a web site link, a nominee's name or picture, or an advertisement of brand image.

FIG. 9C shows a ready-to-shoot page 93 that is provided for the user ready to take a picture or video when the user arrives at the POI. This POI 932 prompts the user that a reward is provided here. In the meantime, the user can immediately take a picture by clicking the shooting button 931.

The present page that allows the user to take the picture or video can be initiated by the user himself or automatically by a program running in the user device. The program continuously checks if the positioning data generated by the user device matches the location of POI. The program can initiate the ready-to-shoot page 93 automatically when the positioning data matches a POI. Therefore, the user can be notified that there is at least one nearby POI with reward and sponsored content is shown by the program executed by the user device even when the user has not planned on going to any POI.

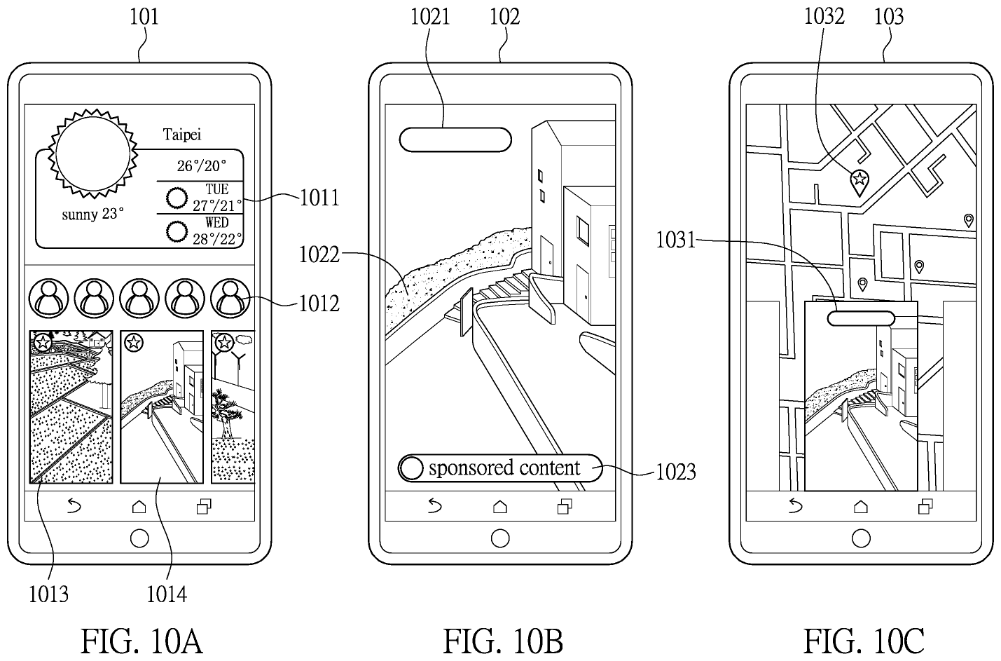

FIGS. 10A through 10C show the schematic diagrams depicting the system providing information of a POI that is explored by the user in the management method under sponsorship according to one embodiment of the disclosure.

FIG. 10A shows that a user uses a program to explore POIs that are not necessarily near the user. A POI exploring page 101 is shown in the diagram. The POI exploring page 101 shows weather information 1011 and related user links 1012 about the POI. The users with the user links 1012 are users that have already created the media content relating to the POI. The page 101 also prompts the user that there are POIs (1013, 1014) with reward nearby if the POIs provide reward.

When the user chooses one of the POIs, a POI page 102 is shown as FIG. 10B. The POI page 102 shows the media content 1022 of the POI, and also prompts that the POI provides reward by a reward prompting icon 1021, and the company or personal sponsored content 1023 is also shown at a specific position.

FIG. 10C further shows a ready-to-shoot page 103 that allows the user to shoot a video via a POI shooting button 1031 when the user arrives at the POI 1032.

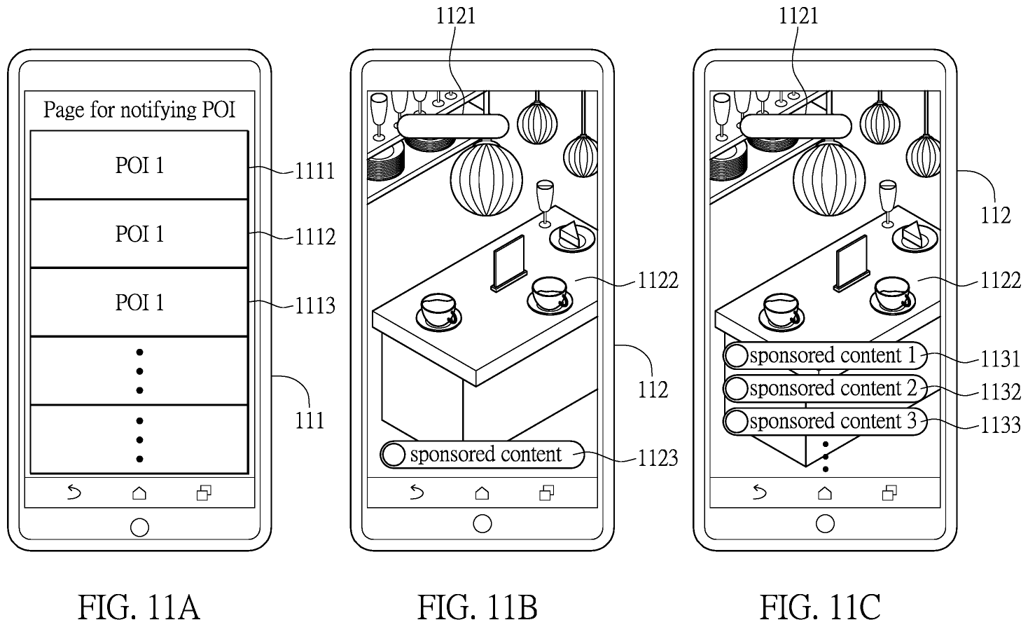

FIGS. 11A and 11B show schematic diagrams depicting the system notifying the user of the POIs with reward in the management method.

FIG. 11A shows a POI notification page 111. When the user carrying a user device arrives at a place, the software program running in the user device transmits positioning data to the user automatically. The present example shows multiple POIs including POI 1 (1111), POI 2 (1112) and POI 3 (1113) with reward when the system queries the database to obtain the nearby POIs with reward. The sponsored content can also be shown at the links of some POIs at the same time.

FIG. 11B shows a POI page 112 that depicts an image when the user clicks one of the nearby POIs with reward. The POI page 112 shows the information such as the media content 1122 and the sponsored content 1123 relating to the POI. A reward prompting icon 1121 is provided to prompt the POI with reward.

In one embodiment, by exploring a geographical range, a positioning data is transmitted to the system. The positioning data can be a center of an area. The system explores the POIs within the geographical area according to a preset policy or a user's configuration. After querying the database, the sponsor can obtain the POIs in association with the positioning data. Each of the POIs may include one or more sponsors. A selection page provides an option for the user to select one or more POIs. When the system receives the selection of POI from the user device, the system also sends the location and identification of each of the POIs back to the user device. The system initiates a POI page. If the POI associates with multiple sponsors, it may associate with multiple sponsored content that can be shown on the POI page by the carousel mode, the side-by-side mode or the option mode.

Reference is made to FIG. 11C, the system will prompt any POI with reward according to an explored result, a browsed data or an invitation made by the system in response to an instant positioning data. After the user selects one of the POIs, the POI page shows the multiple sponsored content that are associated to the POI. The diagram schematically shows the POI with a first sponsored content 1131, a second sponsored content 1132 and third sponsored content 1133. The sponsored content can be shown using a side-by-side mode. If the space is insufficient, or based on the system's setting, a sorting policy can be applied to show the option for the user to select.

In conclusion, according to the embodiments of the method and the system for managing the media content for POI under sponsorship, the system implements a service under sponsorship that rewards a user when he arrives at a POI within a geographical range and meets a criterion. The sponsorship may not be limited to any specific location but to the POIs within a geographical range. The user does not get the reward until he arrives at a specific location. Therefore, the effect of advertisement can also be rated. It is possible for any user to get the instant reward because a sponsorship criterion motivates the user who meets the criterion to arrive at a specific or location. The criterion relates to the sponsored POI that associates with sponsored content. The method and system are therefore a novel service for sponsored advertisement.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for managing media content for POI (Point Of Interest) under sponsorship, operated in a server of a system for managing media content for POI, comprising:
the server receiving a positioning data generated by a user device via a network;
in the server, querying a database for obtaining one or more POIs corresponding to the positioning data;
providing information including a POI location of each POI with reward by the user device if one or more POIs with reward corresponding to the positioning data is found;
the system providing information including at least a POI location of the POI with reward to the user device if any POI with reward is included in the one or more POIs, wherein the POI with reward is set as a sponsored location by one or more sponsors through the system, and the POI with reward associates with one or more sponsored data;
the server receiving media content from the user device; and
providing a reward if the media content is verified to match a reward criterion based on a location where the media content has been created.

2. The method as recited in claim 1, wherein the positioning data is generated when the user device is used to search POIs within a range via an electronic map.

3. The method as recited in claim 2, wherein the one or more POIs within the range is displayed using the user device, and any POI with reward will be labeled.

4. The method as recited in claim 3, wherein, when one POI with reward is selected by the user device, a POI page with a reward prompting icon, one or more sponsored content, and a POI media is displayed.

5. The method as recited in claim 1, wherein a positioning circuit of the user device generates the positioning data when the user device is at a location.

6. The method as recited in claim 5, wherein, when any POI with reward is found by querying the database according to the positioning data, an invitation message is transmitted to the user device proactively, and the POI location and the reward criterion of the POI with reward are provided.

7. The method as recited in claim 6, wherein a selection page showing an option with multiple POIs is provided if multiple POIs with rewards corresponding to the positioning data are found.

8. The method as recited in claim 7, wherein, when one of the POIs is selected by the user device, the POI location corresponds to the positioning data.

9. The method as recited in claim 1, wherein, when the user device is used to browse a plurality of POIs, the server queries the database for providing data of each POI; when one of the POIs is selected, a POI page is displayed and the POI location corresponds to the positioning data.

10. The method as recited in claim 9, wherein, when the system receives one of the POIs is selected from the user device, multiple sponsored content is displayed on the POI page under a carousel mode, a side-by-side mode or an option mode if the POI corresponds to the multiple sponsored content.

11. The method as recited in claim 10, wherein the POI represents one or more POIs with a type of geographical range, or a plurality of POIs with a plurality of types.

12. The method as recited in claim 1, wherein, if it is verified that the media content matches the reward criterion, a media content link corresponding to the POI location is created in the server.

13. The method as recited in claim 1, wherein a sponsor sets up the POI reward through a sponsored content setting page provided by the server, and the setting also includes a POI name, the POI location, a sponsored content, a sponsorship time, a target user condition and the reward criterion.

14. The method as recited in claim 13, wherein the sponsorship time indicates a time for prompting the POI with reward via the user device.

15. The method as recited in claim 13, wherein the target user condition is a filter set by the sponsor for filtering the users who are able to obtain the reward, the target user condition is one or any combination of selected from the user's gender, location, age and a tracking number with respect to the user.

16. The method as recited in claim 13, wherein the reward criterion is a threshold set by the sponsor for filtering the users to obtain the reward, the reward criterion is one or any combination of a location and a time for creating the media content, video content and an action.

17. A system for managing media content for POI under sponsorship, comprising:
a server, by one or more processors of the server, performing a method for managing media content for POI; and
a database, associated with the server, recording a plurality of POIs set up by a plurality of sponsors, and a POI name, a POI location, a sponsored content, a sponsorship time, a target user condition and a reward criterion with respect to each of the POIs;
wherein the management method comprises:
receiving a positioning data generated by a user device via a network;
querying the database for obtaining one or more POIs corresponding to the positioning data;
the system providing information including at least a POI location of the POI with reward to the user device if any POI with reward is included in the one or more POIs, wherein the POI with reward is set as a sponsored location by one or more sponsors through the system, and the POI with reward associates with one or more sponsored data;
receiving media content from the user device; and
providing a reward if the media content is verified that it matches a reward criterion based on a location where the media content has been created.

18. The system as recited in claim 17, wherein, in the management method, the positioning data is generated when the user device is used to search POIs within a range via an electronic map, and one or more POIs within the range is displayed using the user device, and any POI with reward will be labeled.

19. The system as recited in claim 18, wherein a POI page including a reward prompting icon, one or more sponsored content, and a POI media is displayed when one of POIs is selected by the user device.

20. The system as recited in claim 17, wherein, in the management method, when the user device is at a location, a positioning circuit of the user device generates the positioning data; when any POI with reward corresponding to the positioning data is found by querying the database according to the positioning data, an invitation message is transmitted to the user device and the POI location and the reward criterion with respect to the POI with reward are also provided.

21. The system as recited in claim 20, wherein a selection page showing an option with multiple POIs is provided if multiple POIs with rewards corresponding to the positioning data are found; a POI page is displayed when the system receives one of POIs selected by the user device, and the POI location corresponds to the positioning data.

22. The system as recited in claim 17, wherein, when multiple POIs are browsed by the user device, information for each of the POIs is provided by querying the database; a POI page is displayed and the POI location corresponds to the positioning data when one of the POIs is selected.

23. The system as recited in claim 22, wherein, when the system receives one of the POIs selected by the user device, multiple sponsored content is displayed on the POI page under a carousel mode, a side-by-side mode or an option mode if the POI corresponds to the multiple sponsored content.

24. The system as recited in claim 23, wherein the POI represents one or more POIs with a type of geographical range, or a plurality of POIs with a plurality of types.

25. The system as recited in claim 17, wherein, in the management method, when it is verified that the media content matches the reward criterion, a media content link corresponding to the POI location is created in the server.

26. The system as recited in claim 17, wherein the target user condition is a filter set by the sponsor for filtering the users who are able to obtain the reward, the target user condition is one or any combination of the user's gender, location, age and a tracking number with respect to the user.

27. The system as recited in claim 17, wherein the reward criterion is a threshold set by the sponsor for filtering the users to obtain the reward, the reward criterion is one or any combination of a location and a time for creating the media content, video content and an action.
